(19) United States
(12) Patent Application Publication
(10) Pub. No.: US 2017/0164783 A1
(43) Pub. Date: Jun. 15, 2017

(54) MULTIPLE FUEL COOKING UNIT

(71) Applicant: SmokeSteak LLC, Park City, KS (US)

(72) Inventors: Christopher T. Sauerwein, Newton, KS (US); Andrew L. Curtis, Park City, KS (US)

(73) Assignee: SmokeSteak LLC, Park City, KS (US)

(21) Appl. No.: 15/260,586

(22) Filed: Sep. 9, 2016

Related U.S. Application Data
(60) Provisional application No. 62/216,905, filed on Sep. 10, 2015.

(51) Int. Cl. A47J 37/07; F24C 3/14; F24C 5/20; F24B 1/20

(52) U.S. Cl. CPC A47J 37/0713; F24B 1/207; F24C 3/14; F24C 5/20; A47J 37/0786

(57) ABSTRACT

A cooking unit may operate using multiple types of fuel to cook food. One or more first heat source, such as gas burners, electrical resistive heaters, and/or other heating technology, may provide radiant heat to a cooking chamber. One or more second heat source, such as a firebox, may provide indirect heat to the cooking chamber, for example by producing smoke. User operable controls and/or an automated control unit may alter the rate at which a fuel and/or air is supplied to one or more heat source.

### CROSS-REFERENCE TO RELATED APPLICATIONS

This application claims the benefit of U.S. provisional patent application No. 62/216,905, entitled “MULTIPLE FUEL COOKING UNIT” and filed on Sep. 10, 2015, and which is incorporated herein by reference.

### FIELD OF INVENTION

The present invention relates to cooking devices. More particularly, the present invention relates to cooking units, such as grills and smokers, capable of use with multiple types of fuels.

### BACKGROUND AND DESCRIPTION OF THE RELATED ART

Cooking food may involve the application of heat to transform a raw or partially cooked food to a consumable state. The application of heat may chemically and/or physically change the food. Some examples of transformations due to the application of heat to food during cooking are the killing potential foodborne pathogens, changes in the texture of the food, and changes in the taste of the food.

Heat used in cooking may be provided by a variety of different sources. Open flames from burning wood may have been the first heat source used by humans to cook food, but a large variety of other heat sources have been employed to cook food. Different types of heat sources may create different transformations during the cooking process and may impart different properties to the resulting cooked food. For example, smoke, such as may be derived from burning wood, may be applied indirectly to slowly heat the food and to impart a pleasant flavor to food such as meats. However, smoke lacks the high temperature needed to create a sear on a piece of meat. On the other hand, flames from propane or natural gas may achieve the high temperatures needed to obtain a desired sear on a piece of meat, but such flames impart little or no desired flavor when used as a heat source.

### SUMMARY OF THE INVENTION

Enclosed cavity cooking equipment, such is often used by home cooks or even professional chefs, include devices such gas or electric ovens, smokers (wood pellet, wood stick, etc.), gas grills, charcoal grills, electric grills, and the like. All of these cooking units have specific benefits but also suffer from specific drawbacks. Conventional household ovens are convenient to operate due to their precise thermostat control and contained cooking environment, but they provide only heat to food without imparting additional flavor. However, ovens do typically provide the ability to cook food via convection and/or radiant heat transfer. Meanwhile, gas grills provide quick and convenient temperature control and, because they can reach high temperatures, may provide for fast cooking. In fact, gas, such as propane or natural gas, may provide the high temperatures needed for searing the surface of food such as steaks or burgers. However, such gas burners provide little flavor related to the heat source and are typically limited to a radiant heat transfer to food. Direct cooking of food on charcoal grills have similar attributes to gas grills, although charcoal grilling does impart flavor from the combustion of the charcoal to the food. However, charcoal takes longer to reach a stable combustion state relative to gas grills or an electrical or gas oven, which can be frustrating for a cook waiting to place the food on a grill. Controlling the temperature and other cooking properties on a charcoal grill is also relatively difficult as compared to gas grills and ovens of various types. While wood smokers exist in many forms, mostly varying with regard to the airflow (such as offset, reverse flow vertical, etc.), smokers are highly specialized cooking devices. Wood smokers utilize convection heat transfer to slowly cook food. Smokers typically impart a high level of flavoring to the food, as the smoke resulting from wood combustion is inherently flavorful, and are also highly effective for low-temperature, long-duration cooking that may be useful to produce particularly flavorful and tender meats. However, wood smokers take considerable time to reach a stabilized temperature and cannot typically generate a high enough temperature to produce a heat transfer rate adequate to sear food. Further, controlling the airflow and fuel supply to a smoker to maintain a desired temperature for cooking food can be extremely challenging.

For a typical home cook or professional chef to obtain the advantages of different cooking units and types of heat sources, that individual must typically own and operate a device devoted to each heat source. For example, a chef must have a gas grill or cooktop to provide high heat searing, an oven to provide a stable temperature for longer duration cooking, and a smoker to impart flavor during a long, flavorful cooking process. To move food from one cooking unit to another to impart the benefits of each individual heat source to the resulting food may be possible, but in practice is both difficult to coordinate and expensive to implement.

The present invention enables the incorporation of multiple heat sources to heat food contained within a single, common cooking cavity. In the examples described herein, the heat sources may comprise a first heat source, such as gas burners, and a second heat source, such as a wood pellet firebox that provides smoke to the cooking chamber. However, more than these two exemplary heat sources may be provided in a single unit in accordance with the present invention. Further, different heat sources may be provided instead of and/or in addition to the heat sources described in examples herein. For example, electrical resistance heating may be used in place of or in addition to these heat sources.

For heat sources that require combustion of a fuel source, a supply of air is required in addition to a supply of fuel. One or more air supplies may be provided in multiple fuel cooking units in accordance with the present invention. In some examples of multiple fuel cooking units in accordance with the present invention, the management of the air supply may enable more than a single type of fuel to be used, either sequentially or simultaneously. For example, in order to effectively smoke food within a cooking chamber the chamber must be sufficiently sealed to retain the smoke in contact with the food. However, a cooking chamber that has been adequately sealed to serve as a smoker may not draw sufficient secondary air for gas combustion (primary air may be supplied in conjunction with the gas). On the other hand, a cooking chamber that draws sufficient secondary air for combustion may be ill-suited for smoking. Multiple fuel cooking units in accordance with the present invention may provide one or more air supply that provides air to one or more heat source (such as a first heat source comprising at least one gas burner and a second heat source comprising a firebox that generates smoke). In some examples, an air supply may be passive, such as an opening in a cooking chamber that may be optionally opened by a user to a varying degree, but in other examples an air supply may be active. For example, an air supply may comprise one or more fan and, optionally, one or more duct or other structure that transmits air blown by the one or more fan to one or more heat source. One or more fan used as an air supply for a multiple fuel cooking unit in accordance with the present invention may comprise a single speed or a variable speed fan controllable to provide an amount of air corresponding to the desired cooking conditions for a given situation and heat source. In some examples, multiple air supplies may be provided, with each of the air supplies providing air primarily to a single heat source. In other examples, a single air supply may provide air to more than one heat source. In some examples using a single air supply, the heat sources may be used only sequentially, in order that the air supply may provide the amount of air desired for the safe operation of the heat source in use at a given time.

A multiple fuel cooking unit in accordance with the present invention may operate in one or more of a manual mode and an automatic mode. A manual mode may be entirely under the direct control of the user. For example, a user may manipulate a gas combustion control valve for one or more burner and may control the rate at which wood for combustion is provided. A user may additionally/alternatively control the rate at which air for combustion of wood in a firebox and/or air for the combustion of gas at burners is provided. For example, individual knobs may be used to ignite one or more propane burner, and a manual sliding, pivoting or removable air inlet plate may be moved to control the amount of air provided for combustion of gas at the burners. When open, such a plate may allow outside air passage through the cavity walls to provide a natural draft to the gas burners. In some examples, one to five square inches of opening may be provided for each burner provided within a multiple fuel cooking unit in accordance with the present invention. When closed, such a block or plate may fully prevent airflow into the chamber.

In other examples, a user may set a cavity temperature and a control unit having computer processor executing computer readable code embodied in a non-transitory medium may control the operation of the multiple heat sources of a system in accordance with the present invention. For example, a user may set a desired cavity temperature and the control unit may operate the heat sources to attain the desired cavity temperature, for example by adjusting the fuel rate and/or airflow for one or more heat source. A user may, in some examples, specify a heat profile over the course of a cooking time, such as a short duration high temperature sear initially followed by a long duration low temperature smoke. In automatic mode, a single control system may be used to dictate the interaction, dependency, and/or cooperation of multiple heat sources. A single thermostat or multiple thermostats may simultaneously control the rate at which fuel and/or air are provided to one or more heat sources for combustion. A single user control may be used to set a temperature and, for example, the amount of smoke desired. The control unit operating to execute computer readable code embodied in a non-transitory media may then automatically adjust a fan speed, turn a fan on or off, provide more or less fuel, control the flow of gas or pellets, etc., in order to attain a desired temperature within the cavity, or a portion of the cavity, and a desired amount of smoke relative to heat provided by other heat sources.

A gas heat source may be used as a single heat source, permitting a multiple fuel cooking unit in accordance with the present invention operate like a propane grill, but a gas heat source may also be used to supplement the heat provided by smoke. In this way, worries of maintaining an adequate chamber temperature during smoking can be addressed by providing a needed temperature boost from one or more gas burner, potentially automatically under the control of the control unit. Alternatively, a smoke may be used as a single source, permitting a multiple fuel cooking unit in accordance with the present invention to operate like a smoker. Accordingly, a multiple fuel cooking unit in accordance with the present invention is flexible and may be used for a wide range of cooking types.

In some examples in accordance with the present invention, a gas burner may be used to heat a chamber for a time prior to commencing with combustion of wood in a firebox for smoking. In such an example, the time required to bring a chamber to a desired temperature is reduced, as warming a cooking chamber using smoke alone may be time consuming. In another example, a user may initially impart a wood combustion flavor via smoke to a steak or other food item for a short duration using the low temperature heat available from the smoke heat source, and then may use gas burners to provide a high temperature to sear the steak and to cook the steak to a desired internal temperature. In other examples, both high intensity heat from one or more burner and flavorful smoke may be provided simultaneously.

The present invention enables multiple fuels to be used as heat sources in a cooking unit. In some examples, the present invention provides a cooking chamber that may be heated using one or more of multiple possible fuels. Not only does the option of using different types of fuel make systems in accordance with the present invention more convenient and adaptable than single purpose cooking units, but the present invention further permits a single food item to be cooked in different ways within the same cooking unit. For example, using systems in accordance with the present invention a piece meat may both be seared using a flame source and smoked to impart flavor. In some examples in accordance with the present invention the different fuel sources may be used sequentially in time, but in other examples in accordance with present invention different fuels may be used simultaneously.

In some examples in accordance with the present invention, a cooking unit may have a contained cooking chamber that may be heated using at least one of propane flames or wood smoke. In other examples in accordance with the present invention, natural gas may be used instead of propane. In yet other examples in accordance with the present invention, other heat sources, such as one or more of a charcoal fire, a wood fire, and/or an electrical heating element(s) may be used. In accordance with the present invention, two or more heat sources may be provided that may be used to heat food in a contained chamber.

The operation of one or more of the at least two heat sources provided in a system in accordance with the present invention may be under direct control of user and/or may be controlled by a computerized control unit executing computer readable code retained in a non-transitory medium to cause the heat sources to operate in a desired or pre-programmed fashion.

A multiple fuel cooking unit in accordance with the present invention may comprise a cooking chamber having at least one rack that retains food to be cooked and a lid openable to access the cooking chamber and closeable to enclose the cooking chamber. The multiple fuel cooking unit may further comprise at least one gas burner within the cooking chamber below the at least one rack, the at least one gas burner receiving a controlled supply of gas for combustion from a gas supply external to the cooking chamber. The multiple fuel cooking unit may further comprise a firebox that combusts solid fuel to generate smoke, the firebox occluded from the at least one rack within the cooking chamber such that combustion of the solid fuel within the firebox cannot directly heat food placed upon the rack, the firebox receiving a controlled supply of solid fuel from a fuel supply external to the cooking chamber. A multiple fuel cooking unit in accordance with the present invention may further comprise a fan that forces ambient air from outside of the cooking chamber and outside of the fire box into the firebox for combustion of solid fuel and/or into the cooking chamber to serve as secondary air in the combustion of gas at a gas burner. A multiple fuel cooking unit in accordance with the present invention may further comprise at least one secondary air inlet, such as but not limited to a venturi, fan, or adjustable opening, that delivers ambient air from outside of the cooking chamber to the at least one gas burner within the cooking chamber. In examples of a multiple fuel cooking unit in accordance with the present invention, the at least one gas burner may combust propane and the gas supply external to the cooking chamber may be a propane supply. In such examples, the firebox may combust wood, such as may be provided in stick and/or pellet form. In examples of a multiple fuel cooking unit in accordance with the present invention the firebox may be located entirely or partially within the cooking chamber and may be occluded from the at least one rack by a deflector plate and/or a plurality of pans interposed between the firebox and the at least one rack. In other examples of a multiple fuel cooking unit in accordance with the present invention, the firebox may be occluded from the at least one rack by locating the firebox external to the cooking chamber and connecting the firebox to the cooking chamber via a smoke carrying connection.

In examples in accordance with the present invention, a multiple fuel cooking unit may comprise a cooking chamber having at least one rack that retains food to be cooked and a lid openable to access the cooking chamber and closeable to enclose the cooking chamber, a plurality of gas burners in a spaced apart relationship along at least half of the length of the cooking chamber below the at least one rack, the plurality of gas burners receiving a controlled supply of gas for combustion from a gas supply external to the cooking chamber, and a firebox that combusts solid fuel to generate smoke, the firebox occupying less than half of the cooking chamber beneath the rack, the firebox receiving a controlled supply of solid fuel from a fuel supply external to the cooking chamber. In some examples in accordance with the present invention, a multiple fuel cooking unit may further comprise a fire deflector interposed between the firebox and the rack to prevent radiant heat from the combustion of solid fuel to directly heat food placed upon the rack. In examples of a multiple fuel cooking unit in accordance with the present invention, a plurality of drip pans may be removably positioned between the at least one rack and the firebox to capture drippings from food cooking upon the at least one rack and to prevent radiant heat from the combustion of solid fuel to directly heat food placed upon the at least one rack. A multiple fuel cooking unit in accordance with the present invention may further comprise at least one fan that forces ambient air from outside of the cooking chamber and outside of the firebox into the firebox for combustion of solid fuel. The at least one fan may additionally or alternatively force ambient air from outside of the cooking chamber and outside of the firebox into the cooking chamber to serve as secondary air in the combustion of gas at the plurality of gas burners. In examples of a multiple fuel cooking unit in accordance with the present invention the solid fuel combusted in the firebox may be wood pellets and the multiple fuel cooking unit may further comprise a wood pellet hopper external to both the cooking chamber and the firebox, the wood pellet hopper retaining a supply of wood pellets for combustion in the firebox, and a solid fuel supply mechanism that conveys wood pellets from the wood pellet hopper to the firebox at a controlled rate. In some examples of a multiple fuel cooking unit in accordance with the present invention the solid fuel supply mechanism may comprise an auger. In examples of a multiple fuel cooking unit in accordance with the present invention, a solid fuel control may adjust the rate at which the solid fuel is conveyed by the solid fuel supply mechanism from the wood pellet hopper to the firebox, and a firebox air supply control may adjust the rate at which the at least one fan forces ambient air into the firebox, and at least one gas supply control may adjusts the rate at which gas is supplied to at least one of the plurality of burners. A multiple fuel cooking unit may further comprise a control unit that adjusts the solid fuel control, the firebox air supply control, and the at least one gas supply control to create a desired temperature within the cooking chamber. In examples of a multiple fuel cooking unit in accordance with the present invention the control unit further may further adjust the solid fuel control, the firebox air supply control, and the at least one gas supply control to create a desired ratio of heat from smoke produced by the firebox and flames produced by the plurality of gas burners within the cooking chamber.

In further examples of multiple fuel cooking unit in accordance with the present invention, a cooking unit may comprise a cooking chamber having a length and a width along a horizontal dimension, the length and width at a given height in a vertical dimension defining a rectangular shape, the length of the rectangular shape being greater than the width of the rectangular shape, the cooking chamber having a depth in the vertical dimension extending from a floor defining the bottom of the cooking chamber and a roof defining the top of the cooking chamber. Such a multiple fuel cooking unit may further comprise at least one rack that retains food to be cooked within the cooking chamber, the at least one rack extending horizontally at a first level within the cooking chamber. Such a multiple fuel cooking unit may further comprise at least one lid openable to access the cooking chamber and closeable to enclose the cooking chamber. Such a multiple fuel cooking unit may comprise a plurality of gas burners in a spaced apart relationship along the length of the cooking chamber at a second level of the cooking chamber, the second level being lower than the first level, the plurality of gas burners being regularly spaced along at least one half of the length of the cooking chamber. Such a multiple fuel cooking unit may further comprise a gas source external to the cooking chamber and connected to each of the plurality of gas burners within the cooking chamber to supply gas for combustion, and may further comprise at least one user controllable valve that regulates the flow of gas from the gas source to the plurality of gas burners from zero gas flow to a predetermined maximum gas flow. Such a multiple fuel cooking unit may further comprise a firebox that combusts wood pellets to generate smoke conveyed to the cooking chamber through a smoke conveying connection, the firebox occluded from the at least one rack to prevent radiant heating of food placed on the at least one rack by combustion of wood within the firebox, a wood pellet hopper external to the firebox and the cooking chamber, the wood pellet hopper enclosed to retain wood pellets for combustion in the firebox, an auger that conveys wood pellets from the wood pellet hopper to the firebox at a rate controllable by the user, a fan that forces ambient air outside of the cooking chamber and outside of the fire box into the firebox for combustion of the wood pellets and a firebox air supply control that adjusts the rate at which the fan forces ambient air into the firebox. In examples of a multiple fuel cooking unit in accordance with the present invention the gas source may provide propane combustible by the plurality of gas burners. In further examples of a multiple fuel cooking unit in accordance with the present invention, the at least one user controllable valve that regulates the flow of gas from the gas source to the plurality of gas burners may comprise one user controllable valve for each of the plurality of gas burners. In examples, a multiple fuel cooking unit in accordance with the present invention may further comprise a fire deflector interposed between the firebox and the at least one rack, and the firebox may be located within a portion of the length of the cooking chamber not occupied by the plurality of gas burners in a spaced apart relationship. In examples of a multiple fuel cooking unit in accordance with the present invention, the unit may further comprise a programmable control unit that executes machine readable code embodied in a non-transitory medium to control the at least one user controllable valve that regulates the flow of gas from the gas source to the plurality of gas burners, the rate at which the auger conveys wood pellets from the wood pellet hopper to the firebox, and the firebox air supply control that adjusts the rate at which the fan forces ambient air into the firebox in order to cook food placed upon the at least one rack within the cooking chamber.

Further examples of a multiple fuel cooking unit are described below in conjunction with the drawings. While described in examples below describing, for illustrative purposes, the use of a plurality of propane gas burners and a single firebox, multiple fuel cooking units in accordance with the present invention may provide additional or different heat sources than described in these examples.

### BRIEF DESCRIPTION OF THE SEVERAL VIEWS OF THE DRAWINGS

Examples of systems and methods in accordance with the present invention are described in conjunction with the attached drawings, wherein:

FIG. 1 illustrates a perspective view of the front of an exemplary multiple fuel cooking unit in accordance with the present invention;

FIG. 2 illustrates a perspective view of the rear of an exemplary multiple fuel cooking unit in accordance with the present invention;

FIG. 3 illustrates a cross-sectional view of an exemplary multiple fuel cooking unit in accordance with the present invention;

FIG. 4 illustrates a further cross-sectional view of an exemplary multiple fuel cooking unit in accordance with the present invention;

FIG. 5 illustrates a schematic view of an exemplary multiple fuel cooking unit in accordance with the present invention;

FIG. 6 illustrates a further schematic view of an exemplary multiple fuel cooking unit in accordance with the present invention;

FIG. 7 illustrates a cross-sectional view of a secondary air inlet that may be used in conjunction with an exemplary multiple fuel cooking unit in accordance with the present invention;

FIG. 8 illustrates a schematic view of an example of airflow within an exemplary multiple fuel cooking unit in accordance with the present invention;

FIG. 9 illustrates a further cross-sectional view of a multiple fuel cooking unit in accordance with the present invention;

FIG. 10 illustrates a further schematic view of an exemplary multiple fuel cooking unit in accordance with the present invention; and

FIG. 11 schematically illustrates a control unit that may automatically control the operation of a multiple fuel cooking unit in accordance with the present invention.

### DETAILED DESCRIPTION

Systems and methods in accordance with the present invention may provide cooking units capable of using multiple fuels to provide heat to cook food. Different fuel sources may impart different properties to food cooked using that fuel source. For example, high temperature radiant heat from a flame (such as from a propane burner) may produce a “sear” on food, while low temperature smoke may impart significant flavor to food. In accordance with the present invention, different fuel sources may be provided within a single cooking unit. Different fuel sources in a cooking unit in accordance with the present invention may be used simultaneously or sequentially in the cooking process. Systems in accordance with the present invention are also versatile, in that a multiple fuel cooking unit may be used to cook food using only a single fuel source when only that individual type of fuel is desired, while under other circumstances enabling a user to use an entirely different type of fuel source to prepare food of a different type.

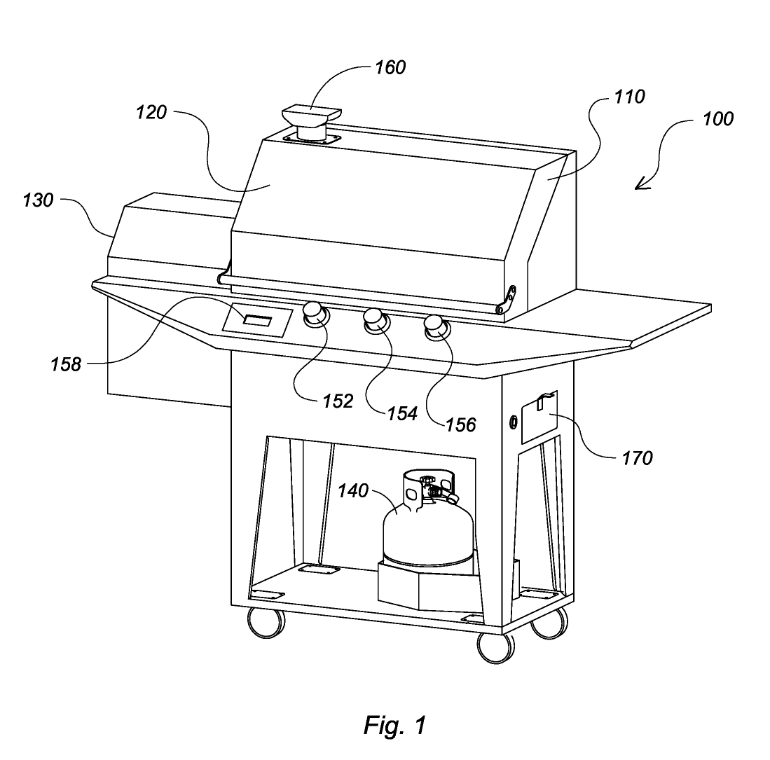

FIG. 1 depicts one example of a multiple fuel cooking unit 100 in accordance with the present invention. Cooking unit 100 may provide a chamber enclosed by a lid 110 to contain food to be cooked. Lid 110 and walls may enclose the cooking chamber when the lid 110 is closed. Lid may have a front 120 that fit with the sidewalls of the unit 100 to permit the cooking chamber to be enclosed when lid 110 is closed and to permit the cooking chamber to be accessible by a user when lid 110 is opened. As described further in examples herein, the chamber may provide one or more racks to hold food during the cooking process and may provide heat sources and/or may receive heat indirectly from heat sources partially or entirely external to the chamber. Lid 110 may be openable using a handle and/or hinges to permit a cook using the cooking unit 100 to access the chamber to place, arrange, and/or inspect food within chamber before or during the cooking process.

One example of a heat source that may be provided in a multiple fuel cooking unit 100 is wood smoke. One example of the use of wood smoke as a heat source in conjunction with a multiple fuel cooking unit is described herein, but other types of wood smoker types and configurations may be used in conjunction with a multiple fuel cooking unit in accordance with the present invention. In the example of FIG. 1, wood pellets may be used to generate smoke. A wood pellet hopper 130 external to the cooking chamber may provide a supply of wood fuel for use in smoke generation, as described in some examples below. Another example of a heat source that may be used in conjunction with a multiple fuel cooking unit in accordance with the present invention is one or more propane burner. In the example described herein, a propane tank 140 external to the cooking chamber may be used to retain propane gas for use to fuel burners to provide heat to cook food within the cooking chamber. A hose or other connection may supply propane from a tank 140 to one or more burner. As can be seen in the example of FIG. 1, both the wood pellet hopper 130 and the propane tank 140 are located external to the cooking chamber, both for safety and for the convenience of operators of the multiple fuel cooking unit 100.

An exhaust 160 may facilitate airflow within the cooking chamber, for example to permit smoke or other vapors to exit from cooking chamber. While exhaust 160 is depicted in the present example as a single pipe extending from a corner of the top of the lid 110, systems in accordance with the present invention are not limited to any particular number or location of an exhaust. As also depicted in accordance with the present example, a door 170 is provided at a lower portion of the cooking chamber. Door 170 may be used to access the bottom of the cooking chamber to clean grease or other debris from food cooked within the cooking chamber of unit 100, to remove ash or suet from the cooking chamber of unit 100, and/or to provide additional airflow though the cooking chamber of unit 100 when door 170 is opened.

Multiple fuel cooking unit 100 may further provide a plurality of controls to permit a user to alter the conditions within the cooking chamber. One example of conditions within the cooking chamber that a user may wish to manipulate is the temperature, but other conditions, such as the humidity, airflow, and ratio of heat applied by different fuel sources may additionally/alternatively be controlled, either directly or indirectly, by a user. In the example of FIG. 1, a first knob 152, a second 154, and a third knob 156 may control parameters such as the rate at which propane is provided to a propane burner, the rate of airflow provided to a burner or firebox, the rate at which wood or charcoal is provided to a heat source, or other parameters. For example, if one of the heat sources provided in a multiple fuel cooking unit 100 comprises an electrical resistance heating element, a knob or other control may be provided to permit a user to vary the heat output provided by such a heat source. By way of further example, if one of the heat sources provided in a multiple fuel cooking unit 100 comprises a propane burner, a knob or other control may be provided to permit a user to vary the rate at which propane is delivered to the burner. By way of yet further example, if one of the heat sources provided in a multiple fuel cooking unit comprises a firebox that produces smoke from burning wood pellets, a knob or other control may be provided to permit a user to vary the rate at which air is provided for combustion and/or the rate at which fuel is delivered to the firebox. Still referring to the example of FIG. 1, a display device 158 may report measured parameters obtained from sensors within the cooking chamber or elsewhere within unit 100 to a user. Display 158 may also be touch sensitive in order to permit display 158 to also comprise an input device to permit user to control the condition(s) within the cooking chamber. The use of a touch sensitive screen that functions as both a display device and an input device may be particularly useful in examples in accordance with the present invention that fully or partially automate the cooking process using a computer processor that controls the heat sources of a multiple fuel cooking unit in accordance with the present invention by executing instructions embodied in computer readable code stored in a non-transitory digital medium.

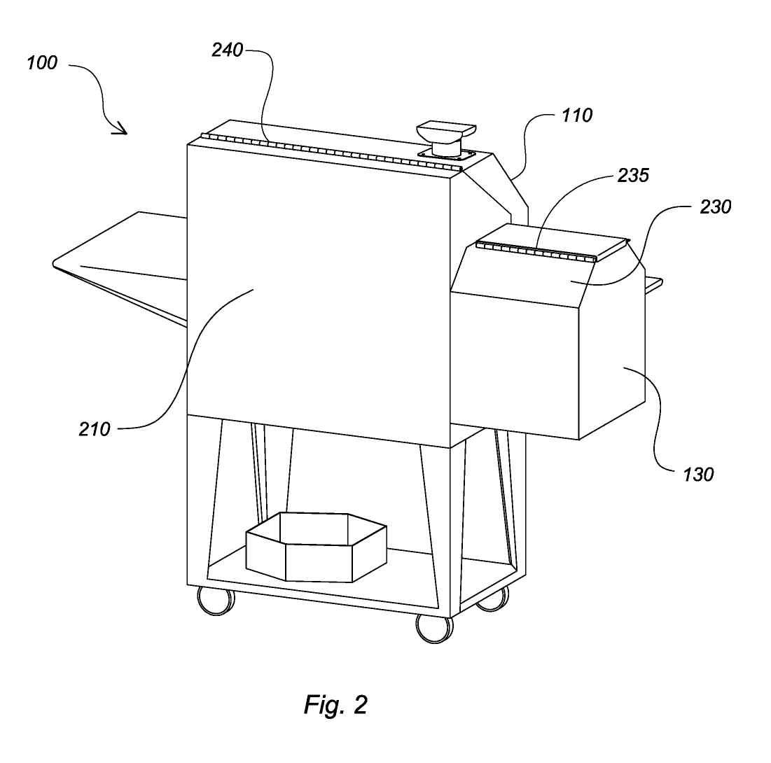

Referring now to FIG. 2, a rear view of the exemplary multiple fuel cooking unit 100 is illustrated. As can be seen in FIG. 2, a back panel 210 may enclose the cooking chamber at the rear of the unit 100. One or more hinge 240 may permit the lid 110 to be opened to access the cooking chamber. The wood pellet hopper 130 may provide a lid 230 that may be opened using hinge 235 to permit a user to access the hopper 130 to add fuel as needed and/or to examine the status of fuel within the hopper 130. Further, a shelf 240 may optionally be provided at the opposing end of the unit 100 from hopper 130 and external to the cooking chamber for use by a cook using the multiple fuel cooking unit 100.

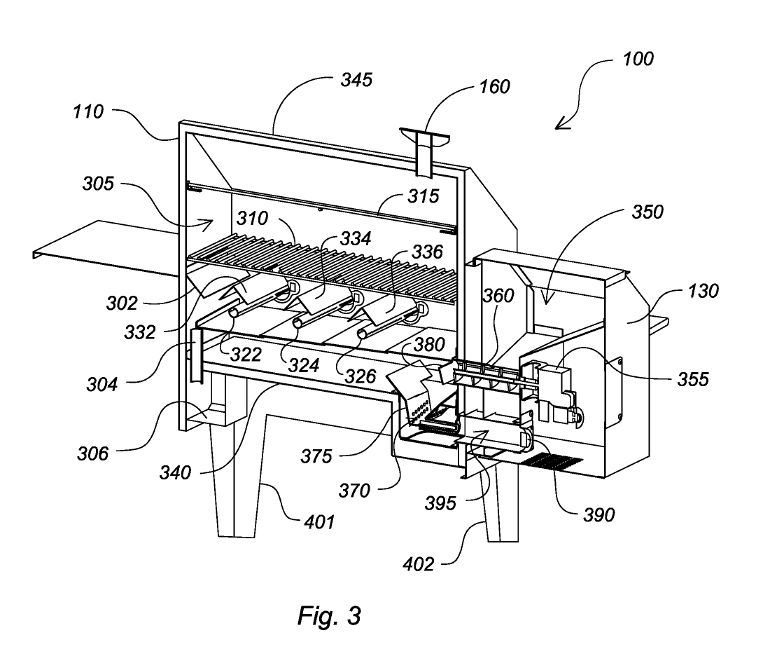

Referring now to FIG. 3, a cutaway view of unit 100 shows an example of a cooking chamber 305 within a multifuel cooking unit 100 in accordance with the present invention. A chamber 305 may extend along a vertical axis from a top 345 to a bottom 340. At least one rack or grate 310 may be provided in a horizontal orientation within chamber 305 to hold food during the cooking process. In the present example, rack 310 is positioned above the heat sources provided by the multiple fuel cooking unit 100, but in other examples the rack may be located differently relative to the heat sources and other elements of the unit 100. While a single rack 310 is illustrated in the example of FIG. 3, multiple racks may be provided in accordance with the present invention. The example of FIG. 3 further shows a warming grate 315 located above cooking rack 310 toward the top 345 of chamber 310. Warming grate(s) 315 may optionally permit food to be retained within cooking chamber 305 more distant from heat sources than the cooking rack 310 in order to maintain a heated temperature for food placed upon the warming grate(s) 315 with little or no cooking of that food.

Still within chamber 305, at least one gas burner may be provided within chamber 305. In the example of FIG. 3, a plurality of gas burners, such as a first burner 322, a second burn 324, and a third burner 326, may be provided within chamber 305 below cooking rack 310. A first burner 322 may be protected by first cover 332, a second burner 324 may be protected by a second cover 334, and a third burner 326 may be protected by a third cover 336. The covers 332, 334, 336 may be constructed of a metal that will retain heat so as to provide radiant heat to cooking rack 310 when the corresponding burner 322, 324, 326 has been activated. The covers 332, 334, 336 may protect the burners 322, 324, 326 from drippings, such as grease, that could be harmful to the physical structure of the burners and could result in flare-ups if the burner is in use.

Still referring to FIG. 3, a deflector 302 may be provided at one or more ends of chamber 305 to deflect drippings from foods cooked upon cooking rack 310 away from the sides of chamber 305 and onto a plurality of drain pans 345 arranged beneath the burners 322, 324, 326. Drain pans 345 may be used to collect clippings from food being cooked within chamber 305 and to protect the bottom 340 of the cooking chamber 305 from damage. A grease drain tube 304 and an outlet 306 accessible via door 170 (shown in the example of FIG. 1) may be provided to receive drippings from the plurality of drain pans 345. As described in an example below, drain pans 345 may be angled within chamber 305 so as to cause drippings collected by drain pans 345 to flow to tube 304. Drain pans 345 may also serve to isolate firebox 370 from cooking chamber 305, so as to provide only indirect heat from smoke to chamber 305 from firebox (rather than direct radiant heat) and to prevent drippings from food from entering firebox 370 in order maintain pure smoke from a desired wood source.

Firebox 370 may receive a supply of wood pellets from hopper 130 when smoke is being used to provide heat to cooking chamber 305 of the multiple fuel cooking unit 100. Hopper 130 may provide a chamber 350 to retain pellets to be burned within firebox 370. An auger 360 operated by a motor 355 may automate the movement of pellets from chamber 350 to firebox 370. Motor 355 may be electrically powered. Within firebox 370, pellets may be ignited using an electric or gas ignition system to provide smoke to chamber 110. A plate 375 may be used to retain pellets that are being burned, to protect pellets from grease or other droppings that may not be retained by pans 345, and to divert smoke from burning pellets within smoke box 370. A fire deflector 380 may further isolate a fire within firebox 370 from the cooking chamber 305 and any drippings that may be produced by food placed upon cooking rack 310. A duct 395 may direct ambient air from outside of the cooking unit 100 and the cooking chamber 305 to the firebox 370 to facilitate the controlled combustion of wood pellets delivered by auger 360 from chamber 350 of hopper 130. A fan 390 may be powered by electricity to force air through duct 395 into the firebox 370. A fixed or variable displacement fan may serve as a single source of air from outside the cooking unit to both a firebox and the gas burners, although in other examples multiple fans and/or passive slidable openings may be provided. By varying the speed of operation of fan 390 the amount of air provided to the firebox 370 and/or the cooking chamber 305 may be varied based upon the air needed to obtain a desired cooking condition. By providing a relatively airtight cooking chamber 305 when lid 110 is close a multiple fuel cooking unit 100 may be used for smoking and/or cooking using a gas burner, but additional secondary air may be needed (either from fan 390 or a secondary air inlet as described in examples below) may be required to obtain adequate and safe combustion of gas in such examples. In some examples, the non-sealed total area for a multiple fuel cooking unit in accordance with the present invention may be less than approximately twenty square inches, although the desired area of the exterior of a unit that permits airflow may vary based upon the number and/or types of combustion-based heat sources provided and/or whether airflow is passive or active (such as may be obtained using a powered fan).

As can be seen in prior figures, legs, such as a first leg 401 and a second leg 402 may retain the entire chamber 305, pellet hopper 130, and other components of a multiple fuel cooking unit 100 in accordance with the present invention at a comfortable height for use by a user. Optionally, wheels, such as lockable wheels that may be temporarily engaged in order to prevent them from turning, may be provided at the bottom terminating ends of some or all of the legs provided for a multiple fuel cooking unit in accordance with the present invention in order to facilitate the movement of the unit by a user.

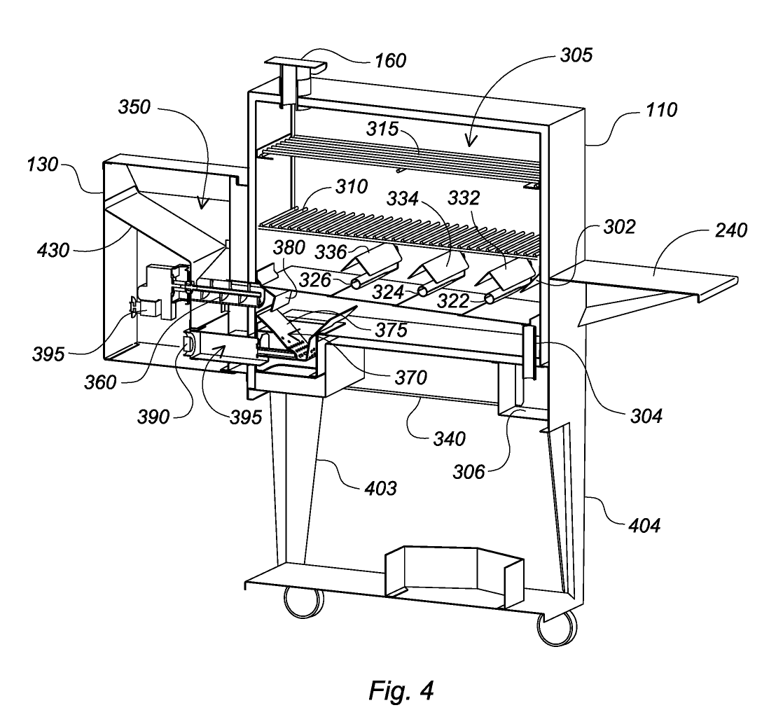

Referring now to FIG. 4, a cutaway from the front perspective of an exemplary multiple fuel cooking unit 100 is illustrated. As can be seen in the example depicted in FIG. 4, a cooking rack 310 may be positioned above a plurality of burners 322, 324, 326, with a warming rack 315 above cooking rack 310. Within wood pellet hopper 130, a chamber 350 that retains a supply of wood pellets may provide an inclined plane 430 that enables gravity to deliver wood pellets placed within chamber 350 to auger 360 to be transported to firebox 370. As can also be seen in FIG. 4, a third leg 403 and a fourth leg 404 (in addition to first leg 401 and second leg 402 described above) may retain the cooking unit 100 at a comfortable height for use by a user.

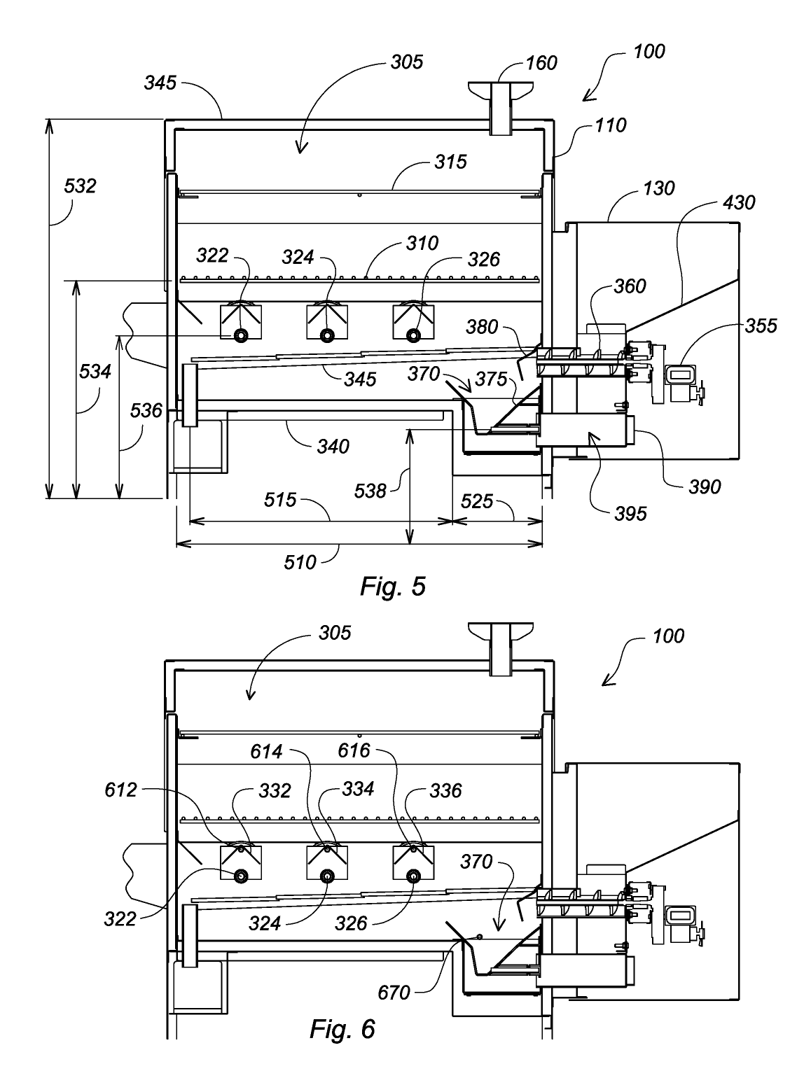

Referring now to FIG. 5, a cross-sectional view of a multiple fuel cooking unit 100 in accordance with the present invention is illustrated. As shown in the example of FIG. 5, portions of the chamber 305 may be occupied by different components of a multiple fuel cooking unit 100 in accordance with the present invention. For example, a chamber 305 may have a length 510 from a first end to a second end along the long axis of the chamber 305 in a horizontal direction. A portion 515 of the total length 510 may be occupied by one or more propane burners, such as burners 322, 324, 326. The one or more burners may be in a spaced apart relationship, while a second portion 525 of total length 510 may be left without a corresponding burner, so as to permit smoking of food placed upon rack 310 in the second portion 525 of length, even if one or more of burners 322, 324, 326 are ignited at the same time. In such an example, the first portion 515 of the cooking rack 310 may be referred to as a radiant heat zone while the second portion 525 of the cooking rack 310 may be referred to as a smoking zone, although smoke from firebox 370 (if in use as a fuel source) may infuse the entirety of chamber 305, including both the smoking zone 325 and the radiant heat zone 315 and one or more of the propane burners 322, 324, 326 may be entirely off so as to provide no radiant heat to all or part of the radiant heat zone 315.

The multiple fuel cooking unit 100 may have a total height 532 with various components as described in examples herein located at different relative heights. For example, a firebox 370 may be located at a first height 538 below the plurality of drain pans 345. Meanwhile, the plurality of burners 322, 324, 326 may be located at a second height 336 above both the firebox 370 and the plurality of drain pans 345. The cooking rack 310 may be located at a third height 534 that is above the plurality of burners 322, 324, 326, and further above the plurality of drain pans 345, and yet further above the firebox 370.

Referring now to FIG. 6, the provision of ignition/fire sensors and/or temperature sensors within a multiple fuel cooking unit 100 in accordance with the present invention is illustrated. For example, a first sensor 612 may be provided in conjunction with a first burner 322, a second sensor 614 may people be provided with a second burner 324, and a third sensor 616 may be provided with a third burner 326. A further, or a fourth, sensor 670 may be provided with firebox 370. While the example of FIG. 6 illustrates the example of four sensors, one devoted to each exemplary heat source, systems and methods in accordance with the present invention are not limited to any particular number or type of sensors, just as systems and methods in accordance with the present invention are not limited to any particular number or type of heat sources. Further, just as the systems and methods in accordance with the present invention are not limited to any particular combination or types of heat sources, systems and methods in accordance with the present invention are not limited to any particular combination, types or kinds of sensors.

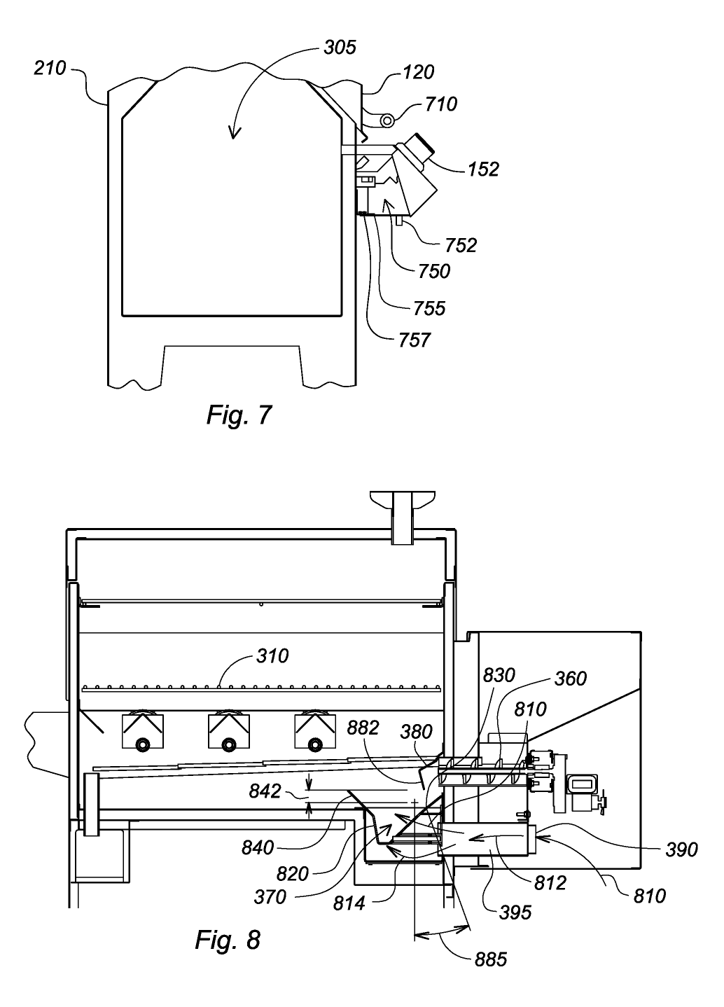

Referring now to the example of FIG. 7, a partial side view of a multiple fuel cooking unit in accordance with the present invention is illustrated. A portion of lid 120 may provide a handle 710 that may be used to lift the lid 120 to permit a user to access chamber 305, although other configurations permitting a user to access a cooking chamber 305 may be used. As depicted in the example of FIG. 1, a control may constitute a knob 152 that permits a user to ignite, activate, and/or otherwise control the heat provided by a heat source, such as a propane burner, a firebox, or other heat source. The panel at the front of the multiple fuel cooking unit 100 may both retain controls such as knob 152, but may further provide a secondary air inlet 750 that may provide a flow of ambient air into the cooking chamber 305. The secondary air inlet 750 may be directly or indirectly controllable by a user to control the secondary airflow within chamber 305 for combustion by one or more gas burner. Secondary air inlet 750 may comprise, for example, a panel 755 that may be slid between an open position and a closed position (or any partially open/partially closed position) using a handle 752, although other mechanical structures may be used to enable a cook to control whether secondary air inlet 750 is open and how much airflow into chamber 305 is permitted by secondary air inlet 750. In some examples, a secondary air fan 757 may force ambient air from outside of the cooking chamber 305 into the cooking chamber 305 for use as secondary air in combustion of gas at one or more burner. Providing both a fan 390 that provides air to a firebox 370 (as depicted in examples above) and a secondary fan 757 (as depicted in the example of FIG. 7) may enable both heat sources to be used simultaneously by enabling safe operation of each heat source and control of the heat output from each heat source. In other examples, however, the secondary fan may be omitted, in which case the secondary air inlet may comprise an opening (that may be opened or closed a desired amount by a user) that provides a passive air supply to the cooking chamber 305. In yet further examples, no secondary air inlet 750 may be provided at all, and secondary air may be provided to the cooking chamber 305 for combustion at one or more gas burner by the fan 390 that provides air to both the firebox 370 and cooking chamber 305. In some examples using only a single fan 390, multiple fuel cooking units in accordance with the present invention may permit only one of the two exemplary heat sources may be activated at a given time in order for the fan 390 to be operated at a speed that supplies an appropriate amount of air for that heat source and the amount of heat desired.

Referring now to the example of FIG. 8, further aspects of an exemplary firebox 370 are illustrated. A duct 395 and a fan 390 may provide airflow from outside the cooking chamber 305 into the firebox 370. Exemplary airflow is indicated by arrows in FIG. 8, as ambient air is drawn 810 from outside of the unit 100 by fan 390, flows 812 through duct 395, and then flows into 816 and around 814 firebox 370. Such airflow provided by fan 390 through duct 395 may thereafter flow into cooking chamber 305 to carry smoke generated in firebox 370 to impart heat and flavor to any food placed upon cooking rack 310. Airflow produced by fan 390 may continue to chamber 305 for optional use as secondary air for combustion of gas at one or more burner. The speed at which fan 390 operates may be varied under the direct or indirect control of a user to provide the amount of air needed for the operation of a given heat source to achieve desired cooking condition(s). In some examples, fan 390 may operate to provide secondary air to chamber 305 even, or in other examples only, when firebox 370 is not in use. While fan 390 may comprise a single speed fan that toggles between an on state and an off state, in many examples of a multiple fuel cooking unit in accordance with the present invention fan 390 may comprise a variable speed fan that may operate at different speeds (and, correspondingly, with air displacement amounts) selectable by a user either directly or indirectly.

Still referring to the example of FIG. 8, firebox 370 may be constructed using one or more metal plate 820 to retain burning wood and/or control the flow of air within firebox 370. Metal plate 820 may be configured to form a bottom region that holds burning wood pellets and/or ash. The bottom region may provide a horizontal base to hold burning wood with angled walls. The bottom region, such as a horizontal base and angled walls, may be solid to retain pellets and/or ash, but in other examples holes may be provided in some or all of the bottom region that are small enough to retain a burning pellet but large enough to permit airflow and, optionally, to discharge ash. A first wall 830 may be angled fifteen to forty-five degrees (from vertical) to facilitate the dropping of pellets from auger 360 to the bottom region of the firebox 370. The first wall 830 may provide air inlet holes to permit airflow 816 through the wall 830. A second wall 840 may extend from the bottom region of firebox 370 for a distance 842 of one to four inches at an angle of between thirty and sixty degrees to control ash deposit. The fire deflector 380 may assist in directing pellets delivered by auger 360 onto the first wall 830 and into the bottom region of firebox 370. A portion 882 of fire deflector 380 may be bent at an angle of between thirty and one hundred-eighty degrees to direct the flow of pellets from auger 360 and to prevent sparks from the bottom region of firebox 370 from entering auger 360. All or part of fire deflector 380 (including portion 882) may provide holes to encourage airflow.

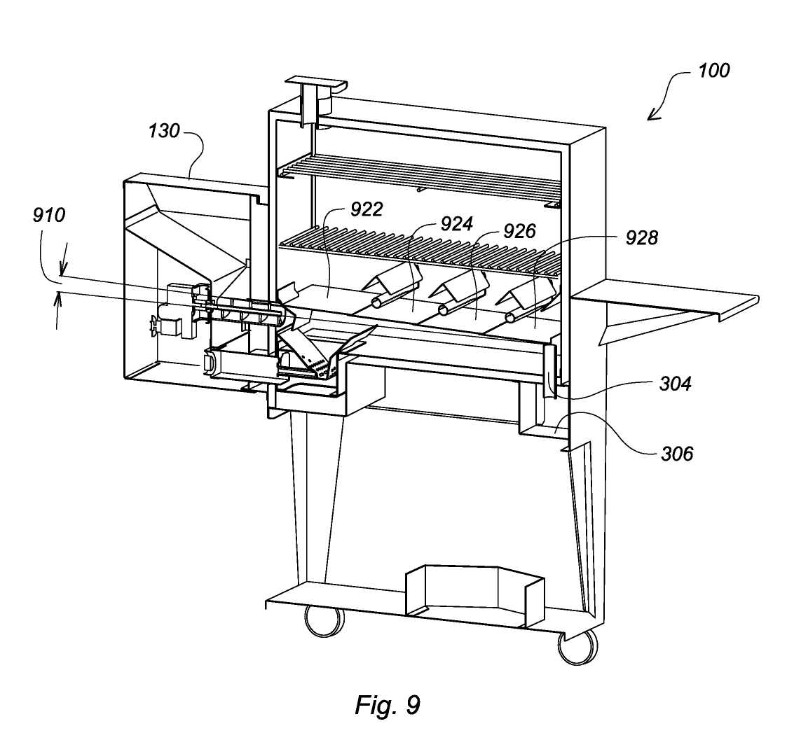

Referring now to the example of FIG. 9, additional details of an exemplary plurality of drain pans (denoted generally as plurality 345 in examples above) is illustrated. The plurality of pans provided in the middle of the cooking cavity may perform a multitude of functions. For example, the pans may function as drip pans to collect drippings from food and to block drippings from entering the firebox where pellet combustion occurs. The pans may also provide an insulating wall to reduce radiate heat transfer from the gas combustion zone to the pellet combustion firebox. In some examples of a multiple fuel cooking unit in accordance with the present invention, it may be possible to reconfigure airflow in the heat unit path from an offset/reverse flow style to a vertical flow style by altering the arrangement of the pans. A sectioned design geometry may permit a condensed vertical profile, while still allowing sectional plan removal without removing gas burners. The plurality of pans may comprise a first pan 922, a second pan 924, a third pan 926, and a fourth pan 928 extending in abutting or overlapping sections from an end of the unit corresponding to a wood pellet hopper 130 to an opposing end of the unit, but more or fewer pans may be used without departing from the scope of the present invention. Each of the plurality of drain pans 922, 924, 926, 928 may be individually removable from the unit for cleaning or replacement. Collectively, the drain pans may be provided with a slope of one to six degrees as indicated by angle 910 to permit drippings from food contained on rack 310 to flow to a drain tube 304. Individual drain pans may be between four and ten inches in width. The drain pans may also have an angle from the front to the back of the unit 100 (or from back to front) to further facilitate the movement of drippings to drain tube 304.

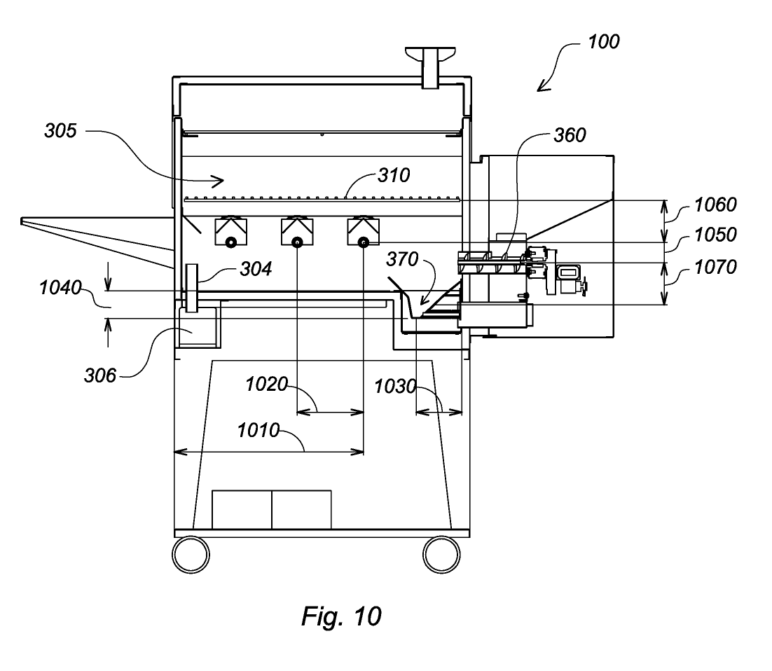

Referring now to the example of FIG. 10, further relational aspects of an exemplary multiple fuel cooking unit 100 are illustrated. Along the length of the cavity 305, a gas heat coverage zone 1010 may comprise one-half to two-thirds of the total length of cavity 305. While the gas burners may be arranged in any fashion within the gas heat zone 1010, in many examples the one or more burners within the gas heat zone 1010 may be provided in an evenly spaced apart relationship having a regular spacing 1020 between individual adjacent burners. Meanwhile, a firebox 370 may occupy a portion 1030 of the chamber 305, which may be some or all of the length of chamber 305 not occupied by the gas heat coverage zone 1010. Meanwhile, the distance 1060 from a cooking rack 310 to the at least one burner 1060 may comprise two to five inches. The auger 360 that feeds wood pellets to the firebox 370 may be located a distance 1050 below the at least one burner, such as approximately four inches below the burner center. Meanwhile, the center of the firebox 370 may be located a distance 1070 below the end of the auger 360 that delivers wood pellets to the firebox 370. The distance 1070 from the end of auger to the center of firebox may comprise four to ten inches.

In operation, foods may be prepared using a multiple fuel cooking unit in accordance with the present invention by heating them within the cavity using heat derived from one or more heat sources. Heat may be applied from multiple heat sources simultaneously and/or sequentially. For example, high heat from one or more propane burner may be used to sear the surface of a piece of meat, and then the slow, tenderizing, and flavorful heat of low temperature smoke may be used to finish cooking the meat. The amount of heat, if any, provided by a given fuel source may be controlled by the user. For example, a user may adjust the amount of propane delivered to a burner within a cooking cavity to control the amount of heat provided by that burner. In the example of a propane burner, the burner may be completely off or, if activated, may be placed at any propane flow rate from a lowest to a highest setting. Any type of valve or other flow regulator may be used to control the propane flow rate in such an example. Similarly, radiant electrical resistance heaters may be powered in a similar fashion to deliver a desirable amount of high intensity direct radiant heating to food. A fuel source such as a firebox that provides smoke may provide indirect heating of food, whether at the same time radiant heat is being provided and/or at a different time. A user may control the amount of smoke provided by an exemplary firebox by controlling the amount of air provided to the firebox, for example by a fan via a duct as described herein, as the combustion rate of wood is highly dependent upon the amount of oxygen available for the combustion. The rate at which wood or other combustible materials (such as charcoal) is provided for combustion may also be varied, for example by modifying the rate at which an auger turns. Similarly, the secondary air provided for the combustion of gas at a propane burner may be adjusted, whether the secondary air is provided by the same fan(s) that supplies air to the firebox or the secondary air is provided by a secondary air inlet (whether passive or active). In some examples, air used for combustion at a propane burner in accordance with the present invention may be provided indirectly via a fan and duct arrangement used for a firebox and/or may be provided by secondary air inlet that permits air to enter a chamber directly near the burner in question. In some examples, one or more fan or venturi may be used to deliver air to a burner within a cooking chamber or to a firebox for combustion.

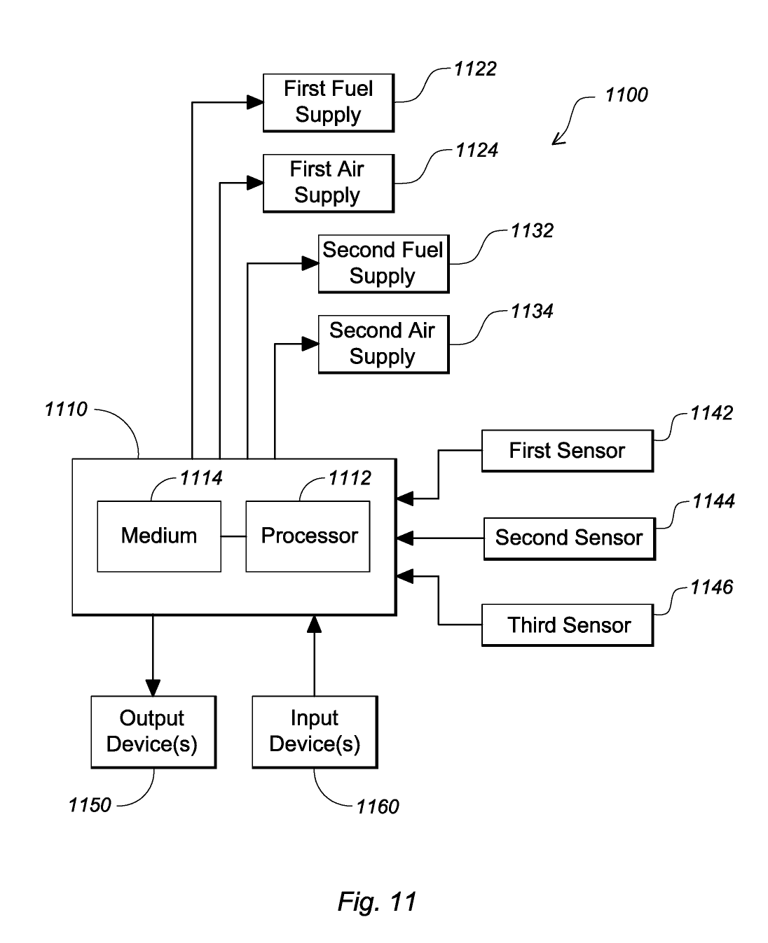

Referring now to FIG. 11, an example of a system 1100 for automatically controlling the operation of a multiple fuel cooking system in accordance with the present invention is illustrated. A control unit 1110 may provide at least one computer processor 1112 that executes computer readable code retained within at least one non-transitory medium 1114 to perform methods in accordance with the present invention. Methods in accordance with the present invention may automatically cook food using heat produced by multiple heat sources using a multiple fuel cooking unit in accordance with the present invention.

One or more input device 1160 may receive input(s) from a user to set cooking parameters. Cooking parameters may comprise, for example, the temperature profile for cooking food and/or a ratio of heat to be applied by various heat sources during cooking, although other cooking parameters such as humidity may be additionally/alternatively used. A temperature profile may comprise the temperature at one or more location within a cooking chamber at a given time during the cooking process. A ratio of heat to be applied may comprise, for example, an amount of smoke to be provided at a given time or for a given duration of a cooking process. One or more output device 1150 may be used in conjunction with the one or more input device to permit a user to select cooking parameters and/or to view the status of a cooking cycle. In some examples, an input device and an output device may comprise a single touch sensitive screen, while in other examples an output device may comprise a screen and input devices may comprise one or more knobs, buttons, and/or keypads.

Based upon entries made by a user via one or more input device 1160 and instructions contained in one or more non-transitory medium 1114, a control unit 1110 may control one or more of a first fuel supply 1122, a first air supply 1124, a second fuel supply 1132, and/or a second air supply 1134 to obtain a desired cooking parameter. For example, a first fuel supply 1122 may be propane gas supplied to one or more gas burner and a second fuel supply 1132 may be wood pellets supplied to a firebox, in which case the first air supply 1124 may be the air available for combustion of gas at the burner(s) and the second air supply 1134 may be the air available for combustion of wood pellets within the firebox. One or more of the first air supply 1124 and the second air supply 1134 may be drawn from outside of an enclosed cooking cavity. In some examples, a single air supply may be used to provide air for both the first and second heating source, such as a gas burner(s) and a firebox that provides smoke, in which case first air supply 1124 and second air supply 1134 may comprise a single air supply.

Cooking parameters may be measured and communicated to control unit 1110 by one or more sensor within the cooking cavity, such as a first sensor 1142, a second sensor 1144, and a third sensor 1146. Sensors may comprise, for example, thermometers placed at desired locations within a cooking chamber and/or on probes inserted into food to be cooked. Measurements from sensors 1142, 1144, 1146 may be displayed to a user via an output device 1150 and/or may be used by the control unit 1110 to determine how to adjust one or more of the first fuel supply 1122, the first air supply 1124, the second fuel supply 1132, and/or the second air supply 1134 in order to achieve desired cooking parameters. In some examples, only a subset of the first fuel supply 1122, the first air supply 1124, the second fuel supply 1132, and the second air supply 1134 may be adjustable by the control unit 1110, while in other examples other parameters, such as additional fuel supplies and/or additional air supplies, may be adjustable by the control unit 1110.

While described in examples herein as having a first fuel supply comprising propane gas and a second fuel supply comprising wood pellets, multiple fuel cooking units in accordance with the present invention may provide more than two fuel supplies and/or heat sources. Further, the fuel supplies and/or heat sources used for multiple fuel cooking units in accordance with the present invention may differ from those described in examples herein. Various types of sensors, if desired, may be used in conjunction with a multiple fuel cooking unit in accordance with the present invention, while in other examples sensors may be dispensed with entirely. Physical configurations of a multiple fuel cooking unit may vary from the examples depicted herein, such as by having different proportions or different geometrical configurations (such as circular or square instead of rectangular).

1. A multiple fuel cooking unit comprising:
a cooking chamber having at least one rack that retains food to be cooked and a lid openable to access the cooking chamber and closeable to enclose the cooking chamber;
at least one gas burner within the cooking chamber below the at least one rack, the at least one gas burner receiving a controlled supply of gas for combustion from a gas supply external to the cooking chamber; and
a firebox that combusts solid fuel to generate smoke, the firebox occluded from the at least one rack within the cooking chamber such that combustion of the solid fuel within the firebox cannot directly heat food placed upon the rack, the firebox receiving a controlled supply of solid fuel from a fuel supply external to the cooking chamber.

2. The multiple fuel cooking unit of claim 1, further comprising a fan that forces ambient air outside of the cooking chamber and outside of the firebox into the firebox for combustion of solid fuel.

3. The multiple fuel cooking unit of claim, wherein the fan that also forces ambient air outside of the cooking chamber and out side of the firebox into the cooking chamber as secondary air for gas combustion at the at least one gas burner.

4. The multiple fuel cooking unit of claim 2, further comprising at least one secondary air source that delivers ambient air from outside of the cooking chamber to the at least one gas burner within the cooking chamber.

5. The multiple fuel cooking unit of claim 4, wherein the at least one gas burner combusts propane, wherein the gas supply external to the cooking chamber is a propane supply, and wherein the firebox combusts wood.

6. The multiple fuel cooking unit of claim 5, wherein the firebox is located within the cooking chamber and is occluded from the at least one rack by a deflector plate interposed between the firebox and the at least one rack.

7. The multiple fuel cooking unit of claim 5, wherein the firebox is occluded from the at least one rack by locating the firebox external to the cooking chamber and connecting the firebox to the cooking chamber via a smoke carrying connection.

8. A multiple fuel cooking unit comprising:
a cooking chamber having at least one rack that retains food to be cooked and a lid openable to access the cooking chamber and closeable to enclose the cooking chamber;
a plurality of gas burners in a spaced apart relationship along at least half of the length of the cooking chamber below the at least one rack, the plurality of gas burners receiving a controlled supply of gas for combustion from a gas supply external to the cooking chamber; and
a firebox that combusts solid fuel to generate smoke, the firebox occupying less than half of the cooking chamber beneath the rack, the firebox receiving a controlled supply of solid fuel from a fuel supply external to the cooking chamber.

9. The multiple fuel cooking unit of claim 8, further comprising a fire deflector interposed between the firebox and the rack to prevent radiant heat from the combustion of solid fuel to directly heat food placed upon the rack.

10. The multiple fuel cooking unit of claim 9, further comprising at least one fan that forces ambient air outside of the cooking chamber and outside of the fire box into the firebox for combustion of solid fuel.

11. The multiple fuel cooking unit of claim 10, wherein the solid fuel combusted in the firebox is wood pellets, the multiple fuel cooking unit further comprising:
a wood pellet hopper external to both the cooking chamber and the firebox, the wood pellet hopper retaining a supply of wood pellets for combustion in the firebox; and
a solid fuel supply mechanism that conveys wood pellets from the wood pellet hopper to the firebox at a controlled rate.

12. The multiple fuel cooking unit of claim 11, wherein the solid fuel supply mechanism comprises an auger.

13. The multiple fuel cooking unit of claim 11, further comprising:
a solid fuel control that adjusts the rate at which the solid fuel is conveyed by the solid fuel supply mechanism from the wood pellet hopper to the firebox;
at least one air supply control that adjusts the rate at which the at least one fan forces ambient air into the firebox; and
at least one gas supply control that adjusts the rate at which gas is supplied to at least one of the plurality of burners.

14. The multiple fuel cooking unit of claim 13, further comprising a control unit that adjusts the solid fuel control, the at least one air supply control, and the at least one gas supply control to create a desired temperature within the cooking chamber.

15. The multiple fuel cooking unit of claim 14, wherein the control unit further adjusts the solid fuel control, the at least one air supply control, and the at least one gas supply control to create a desired ratio of heat from smoke produced by the firebox and flames produced by the plurality of gas burners within the cooking chamber.

16. A multiple fuel cooking unit comprising:
a cooking chamber having a length and a width along a horizontal dimension, the length and width at a given height in a vertical dimension defining a rectangular shape, the length of the rectangular shape being greater than the width of the rectangular shape, the cooking chamber having a depth in the vertical dimension extending from a floor defining the bottom of the cooking chamber and a roof defining the top of the cooking chamber;
at least one rack that retains food to be cooked within the cooking chamber, the at least one rack extending horizontally at a first level within the cooking chamber;
at least one lid openable to access the cooking chamber and closeable to enclose the cooking chamber;
a plurality of gas burners in a spaced apart relationship along the length of the cooking chamber at a second level of the cooking chamber, the second level being lower than the first level, the plurality of gas burners regularly spaced along at least one half of the length of the cooking chamber;
a gas source external to the cooking chamber and connected to each of the plurality of gas burners within the cooking chamber to supply gas for combustion;
at least one user controllable valve that regulates the flow of gas from the gas source to the plurality of gas burners from zero gas flow to a predetermined maximum gas flow;
a firebox that combusts wood pellets to generate smoke conveyed to the cooking chamber through a smoke conveying connection, the firebox occluded from the at least one rack to prevent radiant heating of food placed on the at least one rack by combustion of wood within the firebox;
a wood pellet hopper external to the firebox and the cooking chamber, the wood pellet hopper enclosed to retain wood pellets for combustion in the firebox;
an auger that conveys wood pellets from the wood pellet hopper to the firebox at a rate controllable by the user;
a fan that forces ambient air outside of the cooking chamber and outside of the fire box into the firebox for combustion of the wood pellets; and
a firebox air supply control that adjusts the rate at which the fan forces ambient air into the firebox.

17. The multiple fuel cooking unit of claim 16, wherein the gas source provides propane combustible by the plurality of gas burners.

18. The multiple fuel cooking unit of claim 17, wherein the at least one user controllable valve that regulates the flow of gas from the gas source to the plurality of gas burners comprises one user controllable valve for each of the plurality of gas burners.

19. The multiple fuel cooking unit of claim 18, further comprising a fire deflector interposed between the firebox and the at least one rack, and wherein the firebox is located within a portion of the length of the cooking chamber not occupied by the plurality of gas burners in a spaced apart relationship.

20. The multiple fuel cooking unit of claim 19, further comprising a programmable control unit that executes machine readable code embodied in a non-transitory medium to control the at least one user controllable valve that regulates the flow of gas from the gas source to the plurality of gas burners, the rate at which the auger conveys wood pellets from the wood pellet hopper to the firebox, and the firebox air supply control that adjusts the rate at which the fan forces ambient air into the firebox in order to cook food placed upon the at least one rack within the cooking chamber.
